(19) United States
(12) Patent Application Publication
(10) Pub. No.: US 2024/0198369 A1
(43) Pub. Date: Jun. 20, 2024

(54) FLUID PRODUCT DISPENSER

(71) Applicant: APTAR FRANCE SAS, Le Neubourg (FR)

(72) Inventor: Stéphane BERANGER, Surtauville (FR)

(73) Assignee: APTAR FRANCE SAS, Le Neubourg (FR)

(21) Appl. No.: 18/286,700

(22) PCT Filed: Apr. 13, 2022
(86) PCT No.: PCT/FR2022/050693

§ 371 Date: Oct. 12, 2023

(30) Foreign Application Priority Data
Apr. 14, 2021 (FR) 2103839

(51) Int. Cl. B05B 11/10; A45D 34/04

(52) U.S. Cl. CPC B05B 11/1081; A45D 34/04; B05B 11/1047; A45D 2200/055

(57) ABSTRACT

The invention relates to a dispenser comprising:
a pump (P) comprising a pump body (P1) defining an inlet (P3),
a cap (1) rigidly connected to two reservoirs, the cap (1) forming a reception cavity (10), the cap (1) defining at least two connecting ducts (16, 151) each connecting one reservoir respectively,
characterised in that the dispenser further comprises an endpiece (2) rigidly connected to the pump body (P1), the endpiece (2) defining an interior space (20) which communicates with the inlet (P3) and at least two through-holes (241, 261) which connect the outside of the endpiece (2) with the interior space (20) thereof, the endpiece (2) being rotatably mounted in the reception cavity (10) in order to establish fluid paths between the connecting ducts (16, 151) of the cap (1) and the through-holes (241, 261) of the endpiece (2).

The present invention relates to a fluid product dispenser comprising a fluid product pump having a pump body defining a fluid product inlet, at least two fluid product reservoirs, and a cap rigidly connected to the fluid product reservoirs. The cap forms a reception cavity, the cap defining two connecting ducts each connecting one fluid product reservoir respectively. Thus, the dispenser can deliver one or more doses by coming from the first reservoir or one or more doses by coming from the second reservoir, even one or more doses coming from the two reservoirs at the same time.

The favoured field of application of the present invention is that of perfumery and of cosmetics, without forgetting pharmacy.

In the prior art, document WO2001000521A1 is already known, which describes a dispenser of this type, however with a particular pump, since this is a mixing pump, comprising two fluid product inlets, each provided with an inlet valve. These inlets are formed at the bottom of the pump body, off-centre with respect to the longitudinal axis of the pump. The mixture of the two fluid products occurs inside the mixing pump. The pump body is received in a cap which forms two connecting ducts, respectively connecting the axial inlets of the pump to two reservoirs. The cap is mounted in the neck of a main reservoir and serves as a support to a second reservoir. The rotation of the pump in the cap makes it possible to make the passage sections vary at the axial inlets, which modifies the proportion between the two reservoirs. The fluid product can thus be dispensed from the main reservoir or the fluid product from the secondary reservoir, or also a proportionate mixture of the two fluid products.

The major disadvantage with this dispenser of the prior art comes from the fact that the pump is particular, with two off-centre inlets, which is not common. It is therefore impossible to use a standard pump in this dispenser. A standard pump is a pump, the body of which is of axial revolution with one single axial central fluid product inlet.

On the other hand, dispenser of document WO2001000521A1 probably suffers from sealing defects, in particular between the pump body and the cap at the two fluid product inlets. Indeed, the variation of passage section is made by a shearing movement between two plates, hence a risky sealing.

The present invention mainly aims to modify the design of this dispenser of the prior art, such that a standard pump can be used. Another aim is to improve the sealings by doing without shearing movement.

To achieve these aims, the present invention proposes a fluid product dispenser comprising a fluid product pump comprising a pump body defining a fluid product inlet, at least two fluid product reservoirs, a cap rigidly connected to the fluid product reservoirs, the cap forming a reception cavity, the cap defining at least two connecting ducts, each connecting one fluid product reservoir respectively, the dispenser further comprising an endpiece rigidly connected to the pump body, the endpiece defining an interior space which communicates with the fluid product inlet of the pump body and at least two through-holes connecting the outside of the endpiece with the interior space thereof, the endpiece being rotatably mounted in the reception cavity of the cap, in order to establish fluid paths between the connecting ducts of the cap and the holes of the endpiece.

Thanks to the endpiece, which forms the interface between the pump body and the cap, a standard design pump can be used, the body of which is rotatably rigidly connected to the endpiece, such that a torque exerted on the pump rotates the endpiece in the cap.

Advantageously, the pump body can have a symmetry of revolution about an axis of revolution, the fluid product inlet being unique and located on the axis of revolution. On the other hand, the through-holes of the endpiece can be axially offset, i.e. located at different axial heights.

Advantageously, the endpiece can comprise a pump neck and the pump can comprise a fixing ring engaged with the pump neck. Thus, the user can hold the fixing ring and rotate it, in order to make the endpiece rotate in the reception cavity of the cap.

According to a feature of the invention, the cap can comprise an axial retaining cavity, the endpiece comprising a skirt engaged in the axial retaining cavity, while enabling the rotation of the endpiece in the cap. The endpiece is therefore axially held on the cap, but can rotate in the reception cavity.

According to another aspect of the invention, the pump body can form an inlet pipe internally defining the fluid product inlet, the endpiece forming a sleeve for the sealed reception of the inlet pipe. This inlet pipe is an absolutely conventional feature for a standard pump.

According to a very interesting embodiment, the endpiece can comprise two cylindrical sections which are respectively rotatably mounted in two drums of the reception cavity of the cap, the holes of the endpiece extend radially and open outwards respectively at the two cylindrical sections. While the pump of the dispenser of document WO2001000521A1 defines two axial inlets, the endpiece defines two radial holes, while the pump conventionally defines one sole and single central axial inlet. The endpiece thus makes it possible to redirect the single axial inlet to two radial holes opening onto cylindrical sections rotatably mounted in respective drums.

Advantageously, the drums can be formed with passage grooves which communicate with the connecting ducts, these passage grooves being able to be respectively aligned with the holes by rotation of the endpiece in the cap. Thus, the rotation of the cylindrical sections in their respective drums can define at least two communication positions corresponding to two fluid paths, wherein one single connecting duct is connected to one single respective hole by a passage groove. Preferably, a third communication position can be provided, wherein the two connecting ducts are simultaneously and respectively connected to the two holes by two other passage grooves, in order to dispense a mixture of fluid products coming from the two reservoirs. In more detail still, the drums can comprise an upper drum and a lower drum, the upper drum advantageously having a diameter greater than the lower drum, each drum forming two passage grooves, the upper drum thus comprising a direct passage groove which is directly connected to the connecting duct, and an indirect passage groove which is connected to the connecting duct by an annular channel, which connects the indirect passage groove to the direct passage groove.

Contrary to document WO2001000521A1, wherein the passage from one inlet to another is done progressively and gradually, the dispenser of the invention passes from one communication position to another, by being separated by non-communication positions. In addition, while there are only two fluid paths in document WO2001000521A1, there are four of them in the dispenser of the invention, since there are four passage grooves, a first for connecting a reservoir to the pump, a second groove for connecting the second reservoir to the pump and two other grooves for simultaneously connecting the two reservoirs to the pump. Moreover, the sealed contact is made cylinder in cylinder in the dispenser of the invention at the cylindrical section engaged in the drums, and not disc on disc, like in the dispenser of document WO2001000521A1.

According to another feature of the invention, the cap can be made of one piece, made of a flexible material, in particular a thermosetting material, such as a silicone. The elastic properties of such a high remanence material ensure the radial sealings over time, a high compatibility with the formulations of the market and a rotation facility of the endpiece in the cap.

According to another aspect of the invention, the cap can form vent channels which connect the fluid product reservoirs to the pump, advantageously through a vent passage formed in the endpiece.

Advantageously, the fluid product reservoirs can comprise a main reservoir and a secondary reservoir, the main reservoir comprising a neck, wherein the cap is removably mounted, the main reservoir supporting a shell, wherein the secondary reservoir is disposed, which is removably supported by the cap, such that the secondary reservoir can be removed from the shell. The secondary reservoir can thus be replaced or filled without opening the main reservoir.

According to a practical embodiment, the main reservoir can comprise a reservoir body and a reservoir cover, which are removably connected together, the reservoir cover forming the neck and supporting the shell, the reservoir cover advantageously forming a tube carrier, to which a secondary dip tube is connected, which is connected to one of the connecting ducts of the cap.

The scope of the invention resides in the fact of designing a duo dispenser (or trio, even more), the selection of doses (single or mixture) of which is done by means of rotating a standard pump. The rotation generates a cylinder in cylinder contact, the sealing of which is optimal, but interrupted by passage grooves. Specific paths for the mixture of doses coming from the two reservoirs is another advantageous feature. Access to the secondary reservoir for its replacement or filling, without opening the main reservoir, is another interesting aspect.

The invention will now be more fully described in reference to the accompanying drawings giving, as a non-limiting example, an embodiment of the invention.

In the figures:

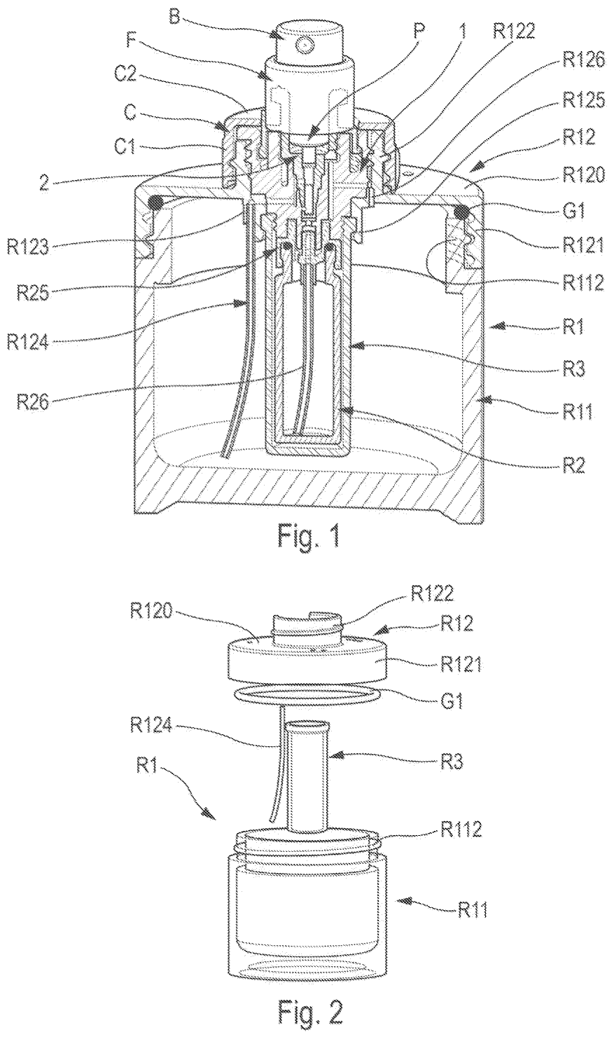

FIG. 1 is a sectional, perspective view of a fluid product dispenser according to the invention,

FIG. 2 is an exploded perspective view of the main reservoir of the dispenser of FIG. 1,

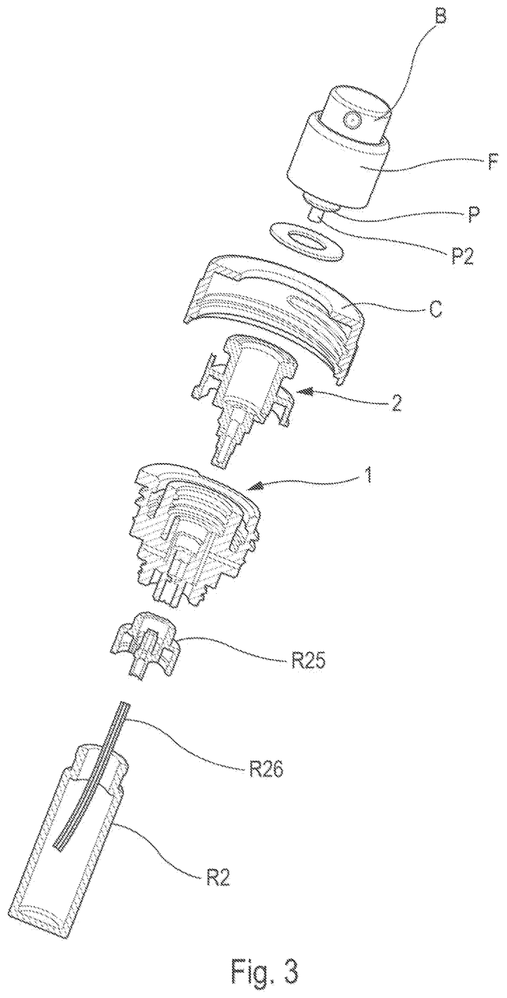

FIG. 3 is a sectional, exploded, perspective view of the elements mounted on the main reservoir of FIG. 2,

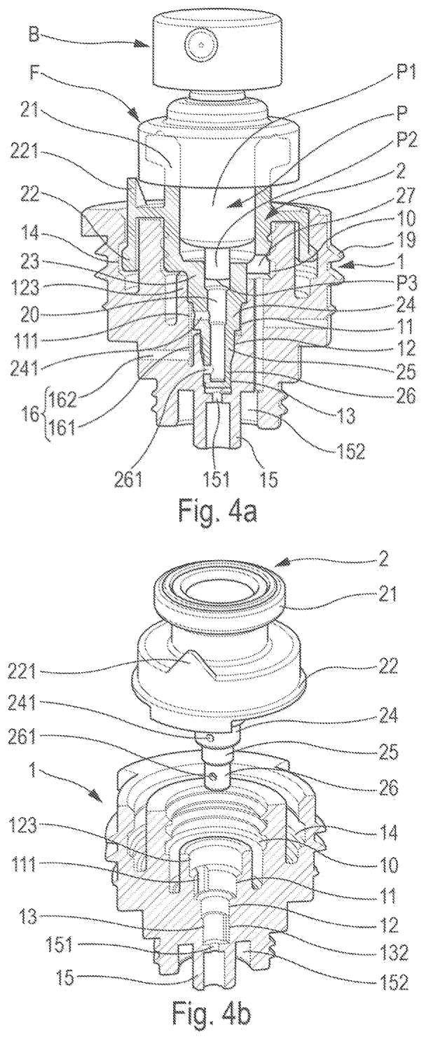

FIG. 4a is an enlarged, sectional, perspective view representing the pump, the cap and the endpiece of the invention,

FIG. 4b is another exploded, sectional, perspective view of the assembly represented in FIG. 4a,

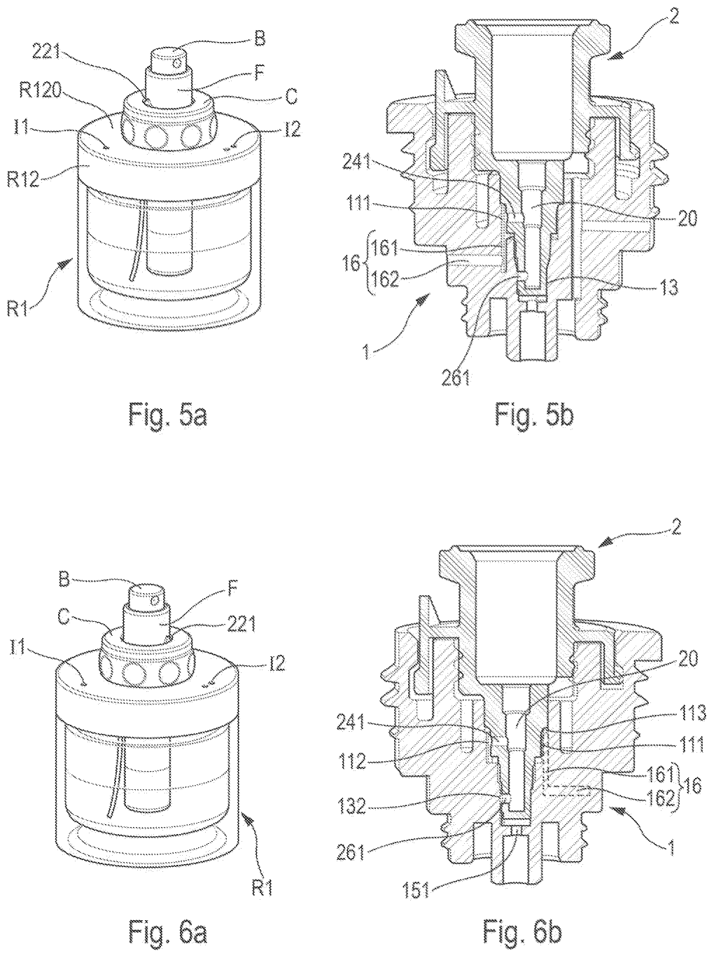

FIG. 5a is a perspective view of the dispenser of FIG. 1 in position 1,

FIG. 5b is a vertical sectional view through the cap and the endpiece in position 1,

FIG. 6a is a view similar to that of FIG. 5a in position 2,

FIG. 6b is a view similar to that of FIG. 5b in position 2,

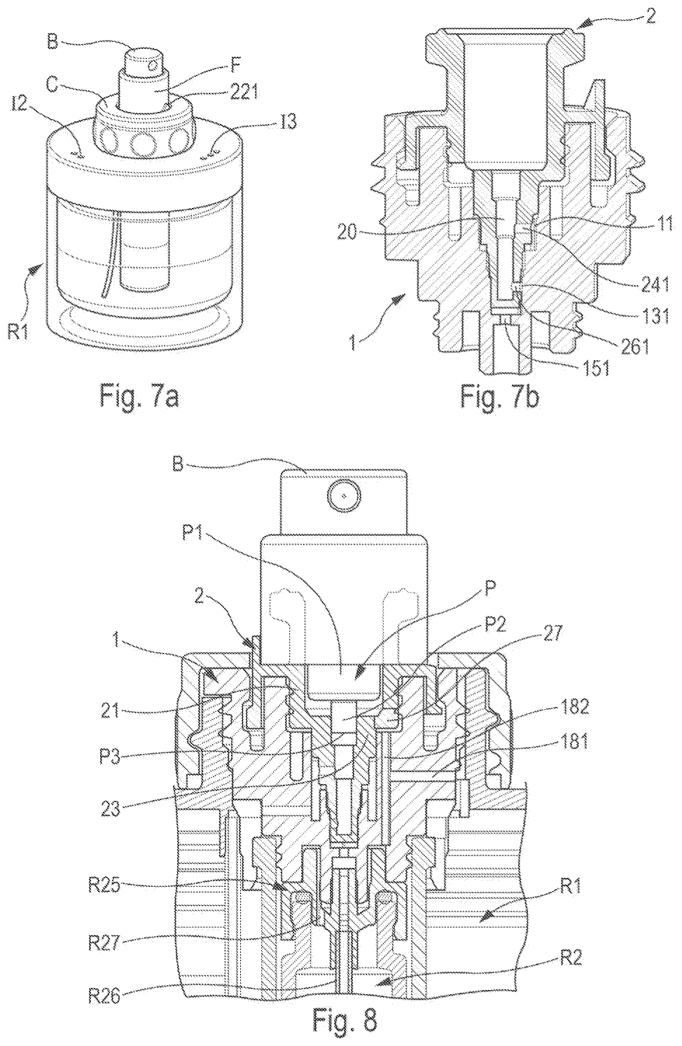

FIG. 7a is a view similar to that of FIGS. 5a and 6a in position 3,

FIG. 7b is a view similar to that of FIGS. 5b and 6b in position 3, and

FIG. 8 is an enlarged, sectional, perspective view aiming to illustrate the vent channels of the dispenser of the invention.

The fluid product dispenser of the invention comprises two fluid product reservoirs, namely a mainly reservoir R1 and a secondary reservoir R2, each containing fluid products which can be identical, but preferably different. It can be noted in FIG. 1, that the secondary reservoir R2 is disposed inside the main reservoir R1. The fluid product dispenser of the invention also comprises a pump P which is provided with a pushbutton B and a fixing ring F. This is a conventional pump comprising a pump body P1 having a symmetry of revolution about an axis of revolution. The pump body defines an inlet pipe P2 internally forming a fluid product inlet P3. This inlet pipe P2 is centrally, axially disposed, and defines the only inlet of the pump, which communicates with a pump chamber through an inlet valve. This design is absolutely conventional for a standard pump, the pump body P1 of which has an axial symmetry of revolution.

The dispenser of the invention also comprises a cap 1 and an endpiece 2, which constitute the core of the invention. The dispenser also comprises a fixing crown C which makes it possible to hold the cap 1 on the main reservoir R1.

The main reservoir R1 can be seen in FIGS. 1 and 2. It comprises a reservoir body R11, which can be presented in the form of a bucket, a pot or a vial, with an opening in the form of a threaded edge R112. The reservoir body R11 can be made of any transparent or opaque material, such as glass, plastic material, metal, etc.

The main reservoir R1 also comprises a reservoir cover R12 which comprises a threaded skirt R121 in threaded engagement with the threaded edge R112 of the reservoir body R11, by advantageously flattening a neck seal G1 between them to create an effective sealing. The cover R12 also comprises an annular shoulder R120 which extends radially inwards from the threaded skirt R121. A cover neck R122 extends upwards from the internal periphery of the plate R120. The cover neck R122 is advantageously threaded on the outside. The reservoir cover R12 also forms snap-fitting tabs R125 which extend downwards inside the main reservoir R1 from the internal periphery of the plate R120. The reservoir cover R12 also forms a tube carrier R123, wherein a main dip tube R124 is engaged, which extends into the main reservoir R1 to the proximity of its bottom. The internal wall of the cover neck 122 is formed with a vent groove R126.

It can be seen in FIGS. 1 and 2, that a shell R3 is fixed to the reservoir cover R12 by snap-fitting at the snap-fitting tabs R125. This shell R3 defines an internal volume, wherein the secondary reservoir R2 is received, as can be seen in FIG. 1.

The cap 1 of the invention is a part which is preferably made of one piece, made of a flexible material, in particular a thermosetting material, such as silicone. The cap 1 is sealingly received inside the cover neck R122. To this end, the cap 1 comprises sealing lips 19 intended to come into sealed pressed contact with the internal wall of the cover neck R122. The cap 1 is held in place using the fixing crown C which forms a socket C1 which is internally threaded. This socket C1 engages threaded with the thread of the cover neck R122. The fixing crown C also comprises a flat flange C2 which makes it possible to press a sealing flange of the cap on the upper edge of the cover neck R122. The cap 1 can be better seen in FIGS. 4a and 4b. The cap 1 defines a reception cavity 10 which mainly has a central axial symmetry. This cavity 10 is intended to receive a part of the endpiece 1, as will be seen below. This cavity 10 comprises a first sealing drum 123, the cylindricity of which is perfect. Below this drum 123, the cavity 10 forms an upper drum 11, the cylindricity of which is interrupted at two axial passage grooves 111 and 112. Below this upper drum 11, the reception cavity 10 defines a second sealing drum 12, the cylindricity of which is perfect. Below this sealing drum 12, the cavity 10 defines a lower drum 13, the cylindricity of which is interrupted at two axial passage grooves 131 and 132. It can be noted that the drums 123, 11, 12 and 13 have decreasing diameters.

The cap 1 also defines an axial retaining cavity 14, which engages with the endpiece 2 as will be seen below.

The cap 1 also defines a connecting duct 16 which connects the axial passage groove 111 to the outside of the cap. This connecting duct comprises a radial duct 161 which is extended by a vertical axis duct 162, which directly connects the axial passage groove 111, as can be seen in FIG. 4a. The cap 1 also defines an axial central connecting duct 151 which communicates directly with the axial passage grooves 131 and 132 of the second lower drum 13. It will be seen below that the second passage groove 112 communicates with the first passage groove 111 by way of an annular channel 113 which can be seen in FIG. 6b.

The cap 1 also defines vent channels which will be described in detail in reference to FIG. 8 below.

In FIGS. 1 and 8, it can be noted that the cap 1 also forms a fixing groove 152 which extends around a tube 15, wherein the central axial connecting duct 151 is formed. This fixing groove 152 receives a ring R25 which is sealingly mounted on the secondary reservoir R2, with an advantageously interposed neck seal. It can be noted that the ring R25 not only enters into the fixing groove 152, but also enters inside the tube 15. This ring R25 also serves as a support or forms a secondary dip tube R26, which can be seen in FIG. 1. It can thus be said that the secondary reservoir R2, thanks to its ring R25, is directly connected to the cap 1, in order to make the inside of the secondary reservoir R2 communicate with the central axial connecting channel 151 through the ring R25 and the dip tube R26.

The endpiece 2 is a part which is preferably made of one piece, made of a polyolefine plastic material, such as PP or thermoplastic polyester, such as PBT or also polyacetal, such as POM. The endpiece 2 comprises a pump neck 21, which can have an absolutely conventional design for a container neck. The fixing ring F of the pump P engages with this pump neck 21 to achieve a fixing which is both solid and sealed. The fixing can be done by snap-fitting, crimping, screwing, etc. The endpiece 2 also comprises an axial retaining skirt 22 which engages with the retaining cavity 14 of the cap. The skirt 2 can be forcibly inserted in the retaining cavity 14, in particular when the cap is made of a flexible material. In a variant, an axial insertion path (not represented) can be provided at the retaining cavity 14 to bring the skirt 22 into the cavity 14. The endpiece 2 is thus rigidly connected to the cap 1, while being able to rotate on itself with respect to the cap 1. The pump neck 21 is extended into its lower part by a sleeve 23, wherein the inlet pipe P2 of the pump 2 is sealingly engaged. Below this sleeve 23, the endpiece 2 forms an interior space 20 which can communicate with the outside through two holes 241 and 261. More specifically, the endpiece 2 forms a first upper cylindrical section 24 below the sleeve 23, which is passed through by the upper hole 241 which extends horizontally and radially. It can thus be said that the hole 241 opens onto the outside at this first upper section 24. Below this first cylindrical section 24, the endpiece 2 forms a cylindrical section 25 which engages perfectly sealingly inside the sealing drum 12 of the cap 1. Below this sealing section 25, the endpiece 2 forms a second lower cylindrical section 26 which is passed through by the second hole 261. It can thus be said that the outlet of the lower hole 261 opens onto the cylindrical section 26. It can be noted that the cylindrical sections 23, 24 and 25 have decreasing diameters. It can also be said that the holes 241 and 261 are offset or axially spaced apart and extend radially.

By referring to FIG. 4a, it can be seen that the sleeve 23 is sealingly engaged in the first sealing drum 123, that the upper cylindrical section 24 is engaged in the grooved upper drum 11, that the cylindrical section 25 is sealingly engaged in the second sealing drum 12 and that the lower cylindrical section 26 is engaged in the grooved lower drum 13.

Still in FIG. 4a, it can be seen that the endpiece 2 is oriented inside the cap 1, such that the first upper hole 241 is positioned at the first upper passage groove 111, which is extended directly by the axial duct 161, which itself is extended by the radial duct 162. Regarding the second lower hole 261, it is blocked by the cylindrical part of the lower drum 13 of the cap 1, such that it cannot communicate with the central axial connecting duct 151. Thus, in this angular position of the endpiece 2 in the cap 1, only the upper hole 241 makes it possible to make the inlet P3 of the pump P communicate with the connecting duct 16.

The endpiece 2 also comprises a slider 221, which is presented in the form of a tip, located in the vertical axial extension of the axial retaining skirt 221, i.e. outside of the pump neck 21.

It can already be understood that the rotation of the endpiece 2 inside the cap 1 makes it possible to establish several fluid paths between the connecting ducts of the cap 1 and the holes of the endpiece 2. The rotation of the endpiece 2 in the cap 1 is done very simply by means of the fixing ring F that the user can quite simply hold and rotate.

The endpiece 2 also comprises a vent passage 27, the function of which will be given below in reference to FIG. 8.

These various fluid paths will now be more fully explained in reference to FIGS. 5a, 5b, 6a, 6b, 7a and 7b, which represent the dispenser in three different dispensing positions, corresponding to three determined angular positionings of the endpiece 2 with respect to the cap 1. These three angular positionings are spaced apart by 120°.

In FIG. 5a, the dispenser of the invention can be seen in the first dispensing position, wherein the slider 221 is aligned with a first position indicator I1, located on the plate R120. This first dispensing position can be reached very simply by making the fixing ring F rotate, which rotates the endpiece 2 in the cap 1 until bringing the slider 221 facing the first indicator I1. In this first dispensing position, the endpiece 2 has an angular orientation determined with respect to the cap 1, as can be seen in FIG. 5b, the endpiece 2 is oriented with respect to the cap 1 in the same way as in FIG. 4. The upper hole 241 of the endpiece 2 is aligned with the first upper passage groove 111 which communicates directly with the connecting duct 16 which opens outside of the cap 1. The radial duct 162 then communicates with the main dip tube R124 which extends inside the main reservoir R1. Regarding the second lower hole 261, it is blocked by the second lower drum 13 of the cap 1.

Thus, in this first dispensing position, the pump P only communicates with the main reservoir R1, through the interior space 20, the upper hole 241, the first passage groove 111, the axial duct 161, the radial duct 162 and the main dip tube R124.

In FIG. 6a, it can be seen that the slider 221 is now aligned with a second position indicator I2. The movement of the slider 221 is done in the same way as above, i.e. by making the fixing ring F rotate. The endpiece 2 is thus positioned angularly with respect to the cap 1, as represented in FIG. 6b. The first upper hole 241 is aligned with the second upper passage groove 112, which communicates with the first upper passage groove 111 by way of an annular channel R113 provided between the cap 1 and the endpiece 2. From this, the communication of the fluid is done as above through the axial duct 161 and the radial duct 162, which is connected to the main dip tube R124. On the other hand, the second lower hole 261 is aligned with the second lower passage groove 132 which communicates directly with the central axial connecting duct 151 to which the secondary dip tube R26 is connected.

Thus, in this second dispensing position, the pump communicates both with the main reservoir R1 and the secondary reservoir R2. The interior space 20 of the endpiece 2 will serve as a mixing chamber, wherein the two fluid products coming from the two reservoirs will be mixed before entering into the inlet P3 of the pump P. The axial channel 161 and the radial channel 162 are represented as a dotted line in FIG. 6b, given that they are offset with respect to the plane of FIG. 6b by 60°.

In FIG. 7a, it is seen that the slider 221 is now aligned with the third position indicator I3, which is offset with respect to the two other indicators I1 and I2 by 120°. The endpiece 2 is thus positioned angularly with respect to the cap 1, as represented in FIG. 7b. It can be seen that the first upper hole 241 is blocked by the upper drum 11, while the second lower hole 261 is aligned with the first lower passage groove 131 which communicates directly with the central axial connecting duct 151, which connects the secondary reservoir R2 by way of the secondary dip tube R26.

Thus, in this third dispensing position, the pump communicates only with the secondary reservoir R2, by way of the internal space 20, of the lower hole 261, of the first lower passage groove 131, the central axial connecting duct 151, and the secondary dip tube R26.

The rotation of the endpiece 2 in the cap 1 therefore makes it possible to define four different fluid paths, namely a first fluid path which connects the pump P to the main reservoir R1 through the first upper axial passage groove 111 in the first dispensing position (I1), a second fluid path connecting the pump P to the secondary reservoir R2 through the first lower axial passage groove in the third dispensing position (I3), and two other fluid paths making it possible for the pump to connect both the main reservoir R1 and the secondary reservoir R2 through the second upper axial passage groove 112 and through the second lower axial passage groove 132 in the second dispensing position (I2). The two upper axial passage grooves 111 and 112 which are offset at 120°, and the two lower axial passage grooves 131 and 132 are also offset at 120° against one another.

Thanks to this dispenser, a user can switch from one dispensing position to another by making the fixing ring F rotate with respect to the main reservoir R1.

In FIG. 8, it can be seen that the dispenser also defines the whole of a channel and vent passage network making it possible to connect the pump P to the two reservoirs R1 and R2. The pump P is preferably an atmospheric pump integrating a specific vent system. Thus, by pressing the pushbutton B, the vent path of the pump 1 is opened. In the scope of the present invention, the pump body P1 is not in direct communication with the two reservoirs R1 and R2. That is why a vent channel network must be defined, making it possible to connect the pump P with the inside of the two reservoirs R1 and R2. First, given that the pump body P1 is not in sealed contact with the pump neck 21, a vent space is defined inside the endpiece 2. Then, this vent space can communicate with vent channels 181 and 182 by way of a vent passage 27 of the endpiece 2, which is presented in the form of an opening where the pump neck 21 connects the sleeve 23. The vent channel 182 connects the secondary reservoir R2 and the vent channel 181 connects the main reservoir R1. More specifically, the vent channel 181 connects the main reservoir R1 through the vent groove R126 which can be seen in FIG. 1. Regarding the vent channel 182, it connects the secondary reservoir R2 by way of a vent hole R27 formed through the fixing ring R25.

In this way, it is guaranteed that the two reservoirs R1 and R2 are always at atmospheric pressure.

It can also be noted that the dispenser of the invention enables an easy filling of the secondary reservoir R2 without having access to the reservoir R1, although the secondary reservoir R2 is disposed inside the main reservoir R1. Indeed, after removal of the fixing ring C, it is possible to remove the cap 1 from the cover neck R122, which leads to the extraction of the secondary reservoir R2 outside of the shell R3, given that the secondary reservoir R2 is directly fixed to the cap 1. Once the reservoir R2 is extracted from the shell R3, it can be easily detached from the cap 1 and replaced by a new or filled reservoir. It suffices then for the user to return the reservoir R2 in place in the shell R3 by pressing the cap 1 into the cover neck R122. The returning in place of the fixing ring C ends the replacement or filling operation.

It can also be noted that it is possible to access directly inside the main reservoir R1 without having to remove the cap 1. It suffices to unscrew the reservoir cover R12 from the reservoir body R11 to fill the main reservoir R1 again.

Thanks to the invention, a dispenser with two reservoirs and single standard pump is available, which makes it possible to easily switch from one reservoir to another or even to the two reservoirs at the same time. The endpiece 2 of the invention is an essential constitutive element which makes it possible to manage the different fluid paths at the same time, but particularly the use of a standard pump.

The description has been made in reference to a dispenser having three different dispensing positions, but it is also possible to limit the dispensing number to two, by removing the second dispensing position, wherein the pump communicates with the two reservoirs at the same time. In this case, the upper drum 11 only comprises one single axial passage groove and the second drum 13 only comprises one single axial passage groove 131. A non-switchable version limited to one single position can even be considered, wherein the pump communicates with the two reservoirs.

1. A fluid product dispenser comprising:
a fluid product pump comprising a pump body defining a fluid product inlet,
at least two fluid product reservoirs,
a cap rigidly connected to the fluid product reservoirs, the cap forming a reception cavity, the cap defining at least two connecting ducts, each connecting respectively a fluid product reservoir,
wherein the dispenser further comprises an endpiece rigidly connected with the pump body, the endpiece defining an interior space which communicates with the fluid product inlet of the pump body and at least two through holes connecting the outside of the endpiece with its interior space, the endpiece being rotatably mounted in the reception cavity of the cap, in order to establish fluid paths between the connecting ducts of the cap and the through-holes of the endpiece.

2. The fluid product dispenser according to claim 1, wherein the pump body has a symmetry of revolution about an axis of revolution, the fluid product inlet being unique and located on the axis of revolution.

3. The fluid product dispenser according to claim 1, wherein the through-holes of the endpiece are axially offset.

4. The fluid product dispenser according to claim 1, wherein the endpiece comprises a pump neck, the pump comprising a fixing ring engaged with the pump neck.

5. The fluid product dispenser according to claim 1, wherein the cap comprises an axial retaining cavity, the endpiece comprising a skirt engaged in the axial retaining cavity, while enabling the rotation of the endpiece in the cap.

6. The fluid product dispenser according to claim 1, wherein the pump body forms an inlet pipe internally defining the fluid product inlet, the endpiece forming a sleeve for the sealed reception of the inlet pipe.

7. The fluid product dispenser according to claim 1, wherein the endpiece comprises two cylindrical sections which are respectively rotatably mounted in two drums of the reception cavity of the cap, the through-holes of the endpiece extend radially and open outwards respectively at the cylindrical sections.

8. The fluid product dispenser according to claim 7, wherein the drums are formed with passage grooves which communicate with the connecting ducts, these passage grooves being able to be respectively aligned with the through-holes by rotation of the endpiece in the cap.

9. The fluid product dispenser according to claim 8, wherein the rotation of the cylindrical sections in their respective drums defines at least two communication positions corresponding to two fluid paths, wherein one single connecting duct is connected to one respective single through-hole by a passage groove.

10. The fluid product dispenser according to claim 9, wherein a third communication position is provided, wherein the two connecting ducts are simultaneously and respectively connected to the two through-holes by two other passage grooves, in order to dispense a mixture of fluid products coming from the two reservoirs.

11. The fluid product dispenser according to claim 10, wherein the drums comprise an upper drum and a lower drum, the upper drum advantageously having a diameter greater than the lower drum, each drum forming two passage grooves, the upper drum thus comprising a direct passage groove which is directly connected to the connecting duct and an indirect passage groove which is connected to the connecting duct by an annular channel, which connects the indirect passage groove to the direct passage groove.

12. The fluid product dispenser according to claim 1, wherein the cap is made of one piece, made of flexible material, in particular a thermosetting material, such as a silicone.

13. The fluid product dispenser according to claim 1, wherein the cap forms vent channels which connect the fluid product reservoirs to the pump, advantageously through a vent passage formed in the endpiece.

14. The fluid product dispenser according to claim 1, wherein the fluid product reservoirs comprise a main reservoir and a secondary reservoir, the main reservoir comprising a neck, wherein the cap is removably mounted, the main reservoir-supporting a shell, wherein the secondary reservoir is disposed, which is removably supported by the cap, such that the secondary reservoir can be removed from the shell.

15. The fluid product dispenser according to claim 14, wherein the main reservoir comprises a reservoir body and a reservoir cover which are removably connected together, the reservoir cover forming the neck and supporting the shell, the reservoir cover advantageously forming a tube carrier to which a secondary dip tube is connected, connected to one of the connecting ducts of the cap.
